(19) United States
(12) Patent Application Publication
(10) Pub. No.: US 2019/0276319 A1
(43) Pub. Date: Sep. 12, 2019

(54) High-Quality Graphene and Method of Producing Same Via Microwave Reduction of Graphene Oxide

(71) Applicant: Rutgers, The State University of New Jersey, New Brunswick, NJ (US)

(72) Inventors: Manish Chhowalla, Highland Park, NJ (US); Damien Voiry, Montpellier (FR); Jieun Yang, Highland Park, NJ (US); Jacob Kupferberg, Toms River, NJ (US)

(21) Appl. No.: 16/328,965

(22) PCT Filed: Aug. 28, 2017
(86) PCT No.: PCT/US17/48832

§ 371 Date: Feb. 27, 2019

Related U.S. Application Data
(60) Provisional application No. 62/382,028, filed on Aug. 31, 2016.

(51) Int. Cl. C01B 32/198; C01B 32/225; C01B 32/192; C01B 32/23

(52) U.S. Cl. CPC C01B 32/198; C01B 32/225; C01B 32/192; C01B 32/23; C01P 2006/40; C01B 2204/22; C01P 2004/03; C01P 2002/85; C01P 2002/82; C01B 2204/02

(57) ABSTRACT

Disclosed are a method of producing microwave-reduced graphene oxide (MW-rGO), by providing graphene oxide; reducing the graphene oxide to obtain reduced graphene oxide (rGO) wherein the reduction of oxygen concentration is sufficient to allow microwaves to be absorbed by the rGO; and microwaving the reduced graphene oxide until microwave-reduced graphene oxide (MW-rGO) containing an oxygen concentration of 5 atomic % or less is produced. The method is a quick and efficient method to produce high quality graphene.

### CROSS-REFERENCE TO RELATED APPLICATIONS

This application claims the benefit of priority of U.S. Provisional Patent Application No. 62/382,028, filed on Aug. 31, 2016, the disclosure of which application is incorporated herein by reference in its entirety.

### FIELD OF INVENTION

The invention relates generally to the field of graphene production, more specifically to methods of producing high-quality graphene.

### BACKGROUND

Graphene is a flat monolayer of carbon atoms tightly packed into a two-dimensional (2D) honeycomb lattice, and is a basic building block for graphitic materials of all other dimensionalities. It can be wrapped up into OD fullerenes, rolled into 1D nanotubes or stacked into 3D graphite. Due to its excellent electronic, thermal and mechanical properties, and its large surface area and low mass, graphene holds great potential for a range of applications. Except for ultrahigh speed electronics, most of the proposed applications require large quantities of high-quality, low cost graphene (preferably solution-processable) for practical industrial scale applications. Examples include energy and hydrogen storage devices, inexpensive flexible electronic devices, and mechanically reinforced conductive coatings and composites including films for electromagnetic interference (EMI) shielding in aerospace applications.

Low yields of single-layered graphene, submicron lateral dimensions, and poor electronic properties remain as major challenges for solution exfoliated graphene flakes. Oxidation of graphite and its subsequent exfoliation into monolayered graphene oxide with large lateral dimensions has an exfoliation yield of about 100%, but despite numerous efforts, it has not been possible to completely remove the oxygen functional groups so that the reduced form of graphene oxide (rGO) remains a highly disordered material with properties that are generally far inferior to chemical vapor deposited (CVD) graphene. Although rGO has been widely demonstrated to be a potentially useful material for catalysis and energy storage, even in its disordered form, efficient reduction of graphene oxide into high-quality graphene should lead to substantial enhancement in performance. Thus, there is a need for a method of reducing graphene oxide into high-quality graphene.

### BRIEF SUMMARY OF THE INVENTION

In one aspect, the disclosed invention is directed to a method for producing microwave-reduced graphene oxide (MW-rGO) by: (a) providing graphene oxide; (b) reducing the graphene oxide to obtain reduced graphene oxide (rGO) wherein the reduction of oxygen concentration is sufficient to allow microwaves to be absorbed by the rGO; and (c) microwaving the reduced graphene oxide until a microwave-reduced graphene oxide (MW-rGO) containing an oxygen concentration of about 5 atomic % or less is produced. The oxygen concentration may be measured by x-ray photoelectron spectroscopy.

In some embodiments, the reduction of oxygen concentration of the rGO at step (b) is about 0.1% or above. In other embodiments, the reduction of oxygen concentration of the rGO at step (b) is about 0.5% or above.

In some embodiments of the method, the graphene oxide is provided by the Hummers' method. In other embodiments, the graphene oxide is provided by the modified Hummers' method.

In some embodiments of the method, the step of reducing the graphene oxide is by annealing the graphene oxide in an inert atmosphere for 1 or more seconds at a temperature of about 20° C. or higher. In other embodiments, the reduction of the graphene oxide is by annealing the graphene oxide in an inert atmosphere for 1 seconds to about 12 hours at a temperature in the range of about 20° C. to about 1500° C., preferably in the range of about 200° C. to about 400° C., more preferably at about 300° C.

In some embodiments of the method, the reduction of the graphene oxide is by using a chemical agent selected from hydrazine, ascorbic acid, hydrohalic acids, sodium borohydride, hydrogen iodide, sulfuric acid, or a combination of thereof.

In some embodiments of the method, the rGO so obtained in step (b) is dry rGO powder. In other embodiments of the method, the rGO so obtained in step (b) is wet rGO powder, preferably the wet rGO powder is not suspended in a liquid. In still other embodiments, the wet rGO powder contains residual chemical agent used for reducing the graphene oxide.

In some embodiments of the method, the rGO so obtained in step (b) is in the form of a single layer film. In other embodiments of the method, the rGO so obtained in step b is in the form of two or more layers film. In some instances, the film thickness can be one or more micrometers. In further instances, the film thickness can be one or more millimeters.

In some embodiments of the methods, the rGO so obtained in step (b) is in the form of 3D structures. In still some embodiments of the methods, the rGO obtained in step (b) is incorporated into insulating matrices. The insulating matrices may be polymer matrices. The insulating matrices may also be ceramic matrices.

In another aspect, the present invention is directed to a method for producing MW-rGO by (a) providing reduced graphene oxide (rGO); and (b) microwaving the reduced graphene oxide until a microwave-reduced graphene oxide (MW-rGO) containing an oxygen concentration of about 5 atomic % or less is produced. in some embodiments, the rGO has been reduced to have a low oxygen concentration so that the rGO can absorb microwaves.

In some embodiments of the method, the step of microwaving the reduced graphene oxide is achieved by irradiating the rGO with electromagnetic radiation in the microwave frequency range of about 300 MHz to about 300 GHz, preferably of around 2.45 GHz for one or more seconds.

In some embodiments of the method, the step of microwaving the rGO is performed with a microwave frequency heating device. The microwave frequency heating device may be a microwave oven with power of about 100 Watt to about 100 kilo Watt. In some instances the oven may be operated at 1000 Watt for 1 or more seconds pulses. The microwave frequency heating device may also be a wave guide. The microwave frequency heating device may further be a resonant cavity.

In some embodiments of the method, the step of microwaving the rGO is performed under an inert gas atmosphere. The inert gas may be argon or nitrogen.

In other embodiments of the method, the step of microwaving the rGO is performed under air.

In another aspect, the present invention is directed to the high-quality graphene produced by the above methods, i.e., the microwave-reduced GO (MW-rGO).

In another aspect, the invention is directed to a method for exfoliating intercalated graphite that has been oxidized, by providing intercalated graphite that has been oxidized; and microwaving the intercalated graphite that has been oxidized to partially remove oxygen from the intercalated graphite that has been oxidized to obtain exfoliated graphene oxide. Intercalated graphite is also known as expanded graphite.

In some embodiments, the exfoliated graphene oxide is simultaneously reduced partially. This partially reduced graphene oxide may be further microwaved to produce high quality microwave-reduced graphene oxide (MW-rGO). In some instances, this MW-rGO contains an oxygen concentration of about 5 atomic % or less.

In some other embodiments, the invention is directed to a method for producing high quality microwave-reduced graphene oxide (MW-rGO) from intercalated graphite that has been oxidized by: (a) providing intercalated graphite that has been oxidized; (b) microwaving the intercalated graphite that has been oxidized to partially remove oxygen from the intercalated graphite to obtain exfoliated graphene oxide; and (c) microwaving the exfoliated graphene oxide to obtain MW-rGO wherein the oxygen concentration is about 5 atomic % or less.

In some embodiments, the step of microwaving the intercalated graphite that has been oxidized is achieved by irradiating the intercalated graphite that has been oxidized with electromagnetic radiation in the microwave frequency range of about 300 MHz to about 300 GHz, preferably around 2.45 GHz for one or more seconds.

In some embodiments, the step of microwaving the intercalated graphite that has been oxidized is performed with a microwave frequency heating device. The microwave frequency heating device may be a microwave oven with power of 100 Watt to 100 kilo Watt. In some instances, the oven may be operated at 1000 Watt for 1 or more seconds pulses. The microwave frequency heating device may also be a wave guide. The microwave frequency heating device may further be a resonant cavity.

In some embodiments of the method, the step of microwaving the intercalated graphite that has been oxidized is performed under an inert gas atmosphere. The inert gas may be argon or nitrogen.

In other embodiments of the method, the step of microwaving the intercalated graphite that has been oxidized is performed under air.

In yet another aspect, the present invention is directed to a microwave-reduced graphene oxide (MW-rGO) produced according to methods disclosed herein for reducing graphene oxide. In some embodiments, the microwave-reduced graphene oxide exhibits sharp G and 2D peaks and a nearly absent or weak D peak in a Raman spectrum. In other embodiments, the microwave-reduced graphene oxide exhibits a highly ordered structure in an analysis by X-ray photoelectron spectroscopy or a high-resolution transmission microscopy.

In still yet another aspect, the present invention is directed to an exfoliated graphite produced according to methods herein disclosed for exfoliating intercalated graphite that has been oxidized.

### BRIEF DESCRIPTION OF THE DRAWINGS

FIG. 1(A) shows a scanning electron microscopy (SEM) image of the single-layer graphene oxide flakes deposited on a silicon wafer. Graphene oxide nanosheets typically have a lateral dimension of about 50 μm. Graphene oxide flakes with lateral dimensions as high as tens of micrometers are shown in FIG. 1(A)

FIG. 1(B) shows a high-resolution x-ray photoelectron spectra (XPS) from the Carbon is regions for microwave-reduced graphene oxide (MW-rGO) compared to pristine graphene oxide (GO), reduced graphene oxide (rGO), CVD-grown graphene and graphite. Each spectrum can be deconvoluted with components from the carbon-carbon bonds (sp³: C—C and sp²: C═C) as well as oxygen functional groups (C—O, C═O and C—O═O) allowing for the quantification of the oxygen content.

FIG. 1(C) shows Raman spectra of MW-rGO and other graphene-based samples. Spectrum obtained for the MW-rGO is similar to the spectrum of the CVD graphene with the presence of a high and symmetrical 2D band together with a minimal D band. Sharp Raman peaks indicate the high crystallinity of MW-rGO and demonstrate the quality of microwave reduction.

FIG. 1(D) shows the evolution of the I_{2D}/I_{G} vs. the crystal size (Lₐ) for MW-rGO, GO, rGO, highly ordered pyrolytic graphite (HOPG), dispersed graphene and graphene from K. R. Paton et al., Scalable production of large quantities of defect-free few-layer graphene by shear exfoliation in liquids, Nat. Mater. 13, 624-630 (2014). Sixty-two (62) measurements on different (˜5) MW-rGO samples are reported. I_{2D}/I_{G} and Lₐ values for MW-rGO are approaching those of CVD graphene and are significantly higher than rGO and dispersed graphene.

FIG. 2 shows high-resolution transmission electron microscopy (HR-TEM) images of MW-rGO nanosheets (scale bar=1 nm). FIG. 2(A) shows a HR-TEM image of a single-layer rGO presenting a high density of defects: holes (lower arrow) and oxygen functional groups (upper arrow). FIG. 2(B) shows a HR-TEM image of a bi-layer MW-rGO showing a highly ordered structure. FIG. 2(C) shows a HR-TEM image of a tri-layer MW-rGO showing a highly ordered structure.

FIG. 3 shows digital pictures showing the formation of arcs during GO microwaving. The pictures were taken about every 50 milli-seconds, starting in the upper left and proceeding in a clockwise direction.

FIG. 4 shows the evolution of the percentage of sp² atoms with the carbon content for GO, rGO, MW-rGO, CVD-grown graphene and graphite obtained from the deconvolution of the C1s regions presented in FIG. 1(B). After microwaving, reduced graphene oxide (MW-rGO) possesses a high amount of carbon, similar to graphite and graphene, and a high percentage of sp² suggesting a large restoration of the conjugated network of the nanosheets, in agreement with Raman spectroscopy.

FIG. 5 shows the 2D band of MW-rGO together with its Lorentzian fit. The 2D band is symmetrical with a FWHM of 36 cm⁻¹, suggesting the presence of single-layer MW-rGO.

FIG. 6(A) shows transfer characteristics of MW-rGO and rGO measured at V_{ds}=50 mV. MW-rGO displays ambipolar behavior with a Dirac cone at Vg˜0.5 V. Inset: Evolution of the MW-rGO conductivity with the carrier density.

FIG. 6(B) shows polarization curves obtained from Ni—Fe layered double hydroxide (LDH) deposited on MW-rGO (Ni—Fe@MW-rGO), rGO (Ni—Fe@rGO) and glassy carbon (Ni—Fe@GC). Inset: The magnification of the onset potential.

FIG. 6(C) shows Tafel plot of Ni—Fe LDH deposited on MW-rGO compared to GC and rGO. Inset: Nyquist plots of the different samples obtained by electrochemical impedance spectroscopy at η=200 mV. Ni—Fe@MW-rGO clearly shows a reduced internal resistance and minimal charge transfer resistance attributed to the high conductivity of the MW-rGO nanosheets.

FIG. 6(D) shows galvanostatic measurements showing the electrocatalytic stability of Ni—Fe LDH deposited on glassy carbon and MW-rGO when driving a 10 mA/cm² current density over 15 h. MW-rGO support shows the best stability with minimal change of the overpotential. At the opposite, the activity from Ni—Fe LDH on glassy carbon decreases rapidly.

FIG. 7 shows carrier mobilities of MW-rGO measured at V_{ds}=25 mV, 50 mV and 100 mV.

FIG. 8(A) shows a scanning electron microscopy image of NiFe@rGO. FIG. 8(B) shows a scanning electron microscopy image of NiFe@MW-rGO. As such, NiFe LDH has similar structure on both rGO and MW-rGO substrates.

FIG. 9(A) shows polarization curves obtained for MoS_{X}@MW-rGO and MoS_{X}@rGO electrodes measured in 0.5 M H₂SO₄, showing the large improvement of the HER activity in the case of MoS_{X}@MW-rGO. Inset: An enlarged plot in the −0.2 to 0.0 potential range to more clearly show the onset potential where the reaction starts.

FIG. 9(B) shows the corresponding Tafel plots for the curves of FIG. 9(A).

FIG. 9(C) shows electrochemical impedance spectroscopy (EIS) data of MoS_{X} on rGO and MW-rGO. Internal resistance (Z_{S}) and charge transfer resistance (Z_{CT}) are significantly reduced to 15Ω and 160Ω respectively, when using MW-rGO due to the combined effect of the high conductivity of microwaved graphene oxide and the low contact resistance from MW-rGO to MoS_{X}. Inset: An enlarged plot in the 0 to 200 Re range to more clearly show the impedance data.

FIG. 9(D) shows galvanostatic measurements over 100 h at 10 mA·cm⁻² for MoS_{X}@rGO and MoS_{X}@MW-rGO, showing the high stability of MW-rGO electrodes.

### DETAILED DESCRIPTION OF THE INVENTION

The present invention is based on our surprising discovery of a quick and efficient method for graphene production. In one aspect, the method of the present invention provides for a simple and rapid method for reducing graphene oxide (GO) into high-quality graphene using microwave irradiation. GO cannot absorb microwaves because GO is electrically insulating. Reduced graphene oxide (rGO) can absorb microwaves due to its increased conductivity as compared to GO, therefore, in accordance with the current invention, GO is at least slightly reduced before undergoing microwave treatment. The method includes providing graphene oxide, reducing the graphene oxide to obtain reduced graphene oxide (rGO) wherein the reduction of oxygen concentration is sufficient to allow microwaves to be absorbed by the rGO, and then microwaving the rGO until microwave-reduced graphene oxide (MW-rGO) containing an oxygen concentration of about 5 atomic % or less is produced. In some embodiments, for example, this high-quality graphene may contain greater than or equal to 95 atomic % carbon and less than or equal to 5 atomic % oxygen that is f-orbital covalently bonded or adsorbed on the graphene.

Graphene oxide may be obtained by any means known in the art. For example, the graphene oxide can be provided by solution exfoliation, by mechanical exfoliation, by the Hummers' method, by the modified Hummers' method, or by microwaving. The provided graphene oxide may contain greater than 5 atomic % oxygen. In some embodiments, the graphene oxide contains 10 to 35 atomic % oxygen. In other embodiments, the graphene oxide contains 5 to 10 atomic % oxygen. In further embodiments, the graphene oxide contains more than 35 atomic % oxygen.

A stable suspension of GO sheets in water may be reconstituted in several different forms such as thin films, bucky paper, or fibers. As GO is electrically insulating because of the presence of oxygen functional groups that are covalently bonded with the carbon atoms. Substantial effort has been devoted to recover the conducting π-states of sp² bonded carbon atoms by removing oxygen functional groups via chemical or thermal reduction, e.g., by even heating over 3000 Kelvin (K). By carefully tuning the reduction procedure, it is possible to realize interesting optical and electronic properties of rGO that are substantially different from those of pristine graphene because the evolution of the oxygen functional groups during reduction is accompanied by the formation of defects in the graphene basal plane. Specifically, nanoscopic holes occur through loss of carbon as CO or CO₂ and rearrangement of the carbon atoms in the graphene basal plane leads to formation of Stone-Wales types of defects. In addition, oxygen functional groups form highly stable ether and carbonyl groups that are difficult to remove so that rGO typically contains a residual oxygen concentration of 15 to 25 atomic percent. These factors render rGO a highly defective material with electronic mobility values on the order of 1 cm²-V⁻¹-s⁻¹.

GO can hardly absorb microwaves because GO is electrically insulating. In contrast, rGO can absorb microwaves due to its increased conductivity as compared to GO. GO has to be slightly reduced before undergoing microwave treatment. In some embodiment, for example, GO is reduced to produce reduced graphene oxide (rGO) with oxygen concentration being reduced by about 0.5% or above. In some other embodiment, for example, GO is reduced to produce rGO with oxygen concentration being reduced by about 0.1% or above. GO can be reduced by numerous methods known in the art to obtain rGO ready for microwaving treatment. In the present invention, GO is reduced to produce rGO wherein the reduction of oxygen concentration is sufficient to allow microwaves to be absorbed by the rGO.

In some embodiments, GO may be reduced through treatment with chemicals including, but not limited to, hydrazine (Park, Nat Commun, 2012; Kiang Chua, Chem Soc Rev, 2014) and similar reducing chemicals and/or their vapors (Moon, Nat Commun, 2010), ascorbic acid (vitamin C), (Zhang, Chem Commun 2010) hydrohalic acids, (Pei, Carbon, 2010) sodium borohydride, (Shin, Adv Funct, Mater, 2009) hydrogen iodide, (Moon, Nat Commun, 2010; Pei, Carbon, 2010) sulfuric acid, (Ashok Kumar, J Mater Chem A, 2013) or a combination of these chemicals.

In other embodiments, GO may also be reduced though UV irradiation. The UV irradiation can be performed using UV lamp in inert environment, air, or in liquids.

In other further embodiments, GO may be suspended in, saturated or partially saturated with a solvent and then undergo microwave treatment. The microwave treatment may heat up the solvent and thereby allow the reduction of GO to obtain rGO. The resulting rGO may be further microwaved to obtain high quality MW-rGO. In some instances, the solvent may evaporate partially or completely before the rGO undergoes further microwave treatment. In some embodiments, the steps of rGO generation and MW-rGO production may be performed in the same microwave apparatus.

In further embodiments, GO may be slightly reduced by thermal annealing. This annealing may be performed prior to exposure to the microwave irradiation, such that the reduced graphene oxide is made to be conducting so that it can absorb microwaves. For example, annealing of the graphene oxide may be performed at about 300° C. for one hour under argon. For another example, annealing of the graphene oxide may be performed in an inert atmosphere for 1 or more seconds at a temperature of about 20° C. or higher. As a further example, annealing the graphene oxide can be performed in an inert atmosphere for a timespan in the range of 1 second to 12 hours at a temperature in the range of about 20° C. to about 1500° C. to obtain the reduced graphene oxide. In some instances, the temperature may be in the range of about 200° C. to about 400° C. In other instances, the temperature is at about 300° C. An inert atmosphere may be created by performing the annealing step in the presence of an inert gas, for example, argon, nitrogen or air. Indeed, any inert gas may be used as the atmosphere for the annealing.

In still further embodiments, a combination of one or more methods of chemicals, UV irradiation, and thermal annealing may be used to obtain rGO.

The reduction of GO may be observed by a decrease of oxygen concentration using x-ray photoelectron spectroscopy. In some embodiments, a decrease of oxygen concentration by as low as 0.5% in GO may be sufficient for the resulting rGO to absorb microwaves. In other embodiments, a decrease of oxygen concentration by as low as 0.1% in GO may be sufficient for the resulting rGO to absorb microwaves. As such slight reduction of GO may allow microwave absorption by the resulting rGO, subsequent microwave treatment of the rGO can lead to superior reduction of the rGO and therefore production of high quality graphene.

In some embodiments, rGO may be in powder form, in the form of thin films, in the form of fibers, (Dong, Adv Mater, 2012; Xin, Science, 2015) in the form of thick films (Chen, Nano Lett, 2016; Dong, Chem Mater, 2017) or in the form of 3D structures (Xu, ACS Nano, 2010). The thin film may be a single layer film. The thick film may be two or more layers in some instances or up to thousands of layers so that the thickness may be one or more micrometers, or one or more millimeters. Any of the above form of rGO is amenable to the microwaving treatments.

In other embodiments, GO can be reduced when being incorporated into insulating matrices known in the art. In some instances, the insulating matrices may be polymer matrices. In other instances, the insulating matrices may be ceramics matrices.

In some embodiments, once the graphene oxide (GO) is slightly reduced, the microwaving step is performed to produce MW-rGO. In other embodiments, reduced graphene oxide, absent any reduction treatment or other pre-processing, is used directly for the microwaving step to produce MW-rGO.

In some instances, the rGO may be irradiated with electromagnetic radiation in the microwave frequency range of about 300 MHz to about 300 GHz, preferably around 2.45 GHz until high-quality graphene is obtained. For example, a microwave frequency of about 2.450 GHz, a wattage from about 100 to 3000 W, and a pulse or pulses from milli- to tens of seconds may be used. As an example, the microwaving can be performed with a conventional microwave oven operated at 1000 W for 1 to 2 second pulses under inert atmosphere to further reduce the rGO in an inert atmosphere. Any inert gas, argon, nitrogen or air may be used as the atmosphere for the microwave treatment.

Electromagnetic radiation of the rGO may be conducted in any microwave frequency heating device, such as a microwave oven, a wave guide, a resonant cavity, and the like. Suitable heating devices are well known in the art and commercially available. For example, the microwave oven may have power of about 100 Watt to about 100 kilo Watt.

In some embodiments, the rGO subject to the microwave treatment may be dry rGO powder. In some instances, the dry rGO has less than 1% liquid by weight. In other instances, the dry rGO has less than 0.1% liquid by weight. In further instances, the dry rGO has less than 0.01% liquid by weight. The liquid may be water or other liquid

In other embodiments, the rGO subject to the microwave treatment may be wet rGO powder. The wet rGO powder may contain water or other liquid. Preferably, rGO in wet powder are not suspected in a liquid. In some instances, the wet rGO powder may contain residual chemical agent used for reducing the graphene oxide in the previous step.

In another aspect, the present invention is directed to the high-quality graphene produced by the above methods, i.e., the microwave-reduced GO (MW-rGO). After the microwaving step, this MW-rGO exhibits pristine CVD graphene-like features in the Raman spectrum with sharp G and 2D peaks and a nearly absent or weak D peak. X-ray photoelectron spectroscopy (XPS) and high-resolution transmission microscopy (HR-TEM) of the MW-rGO suggest a highly ordered structure in which oxygen functional groups are almost completely removed. Previously, there has not been a method where solution processed graphene gives a Raman spectrum that is comparable to CVD graphene. The excellent structural properties are translated into mobility values of ˜1500 cm²-V⁻¹-s⁻¹ in field effect transistors (FETs) with MW-rGO as the channel material and in exceptionally low Tafel slope values of ˜38 mV/decade for MW-rGO catalyst support for oxygen evolution reaction (OER). These results suggest that reduction of GO using microwaves is highly efficient and realizes the goal of achieving high-quality graphene with excellent properties by solution exfoliation.

In accordance with the present invention, the microwave-reduced GO (MW-rGO) can be utilized, for example, in applications requiring heat dissipation, in applications requiring thermal conductivity, in applications requiring mechanical strength, in 2D- and 3D-printable electronics applications (e.g., graphene-based ink), as a catalyst support, and in energy storage applications (e.g., electrodes used in batteries).

In a still another aspect, the present invention is directed to for exfoliating intercalated graphite by providing intercalated graphite that has been oxidized, and then microwaving the intercalated graphite that has been oxidized to partially remove oxygen from the intercalated graphite that has been oxidized to obtain exfoliated graphene oxide.

The intercalated graphite that has been oxidized may be obtained by methods known in the art. Methods of how intercalated graphite is obtained are described in these references, which are hereby incorporated by reference in their entireties (Hummers, J Am Chem Soc, 1958; Chua, Chem—Eur J, 2012).

The intercalated graphite that has been oxidized may be irradiated with electromagnetic radiation in the microwave frequency range of (about 300 MHz to about 300 GHz, preferably around 2.45 GHz until the graphite is exfoliated. For example, a typical microwave frequency of 2450 MHz, a wattage from 100 to 3000 W, and a pulse or pulses from milli- to tens of seconds may be used. As an example, the microwaving can be performed with a conventional microwave oven with power of 100 Watt to 100 kilo Watt. In some embodiments, the microwave oven may be operated at 1000 W for 1 to 2 second pulses under inert atmosphere to reduce the graphene oxide. An inert atmosphere may be created by microwaving the intercalated graphite in the presence of an inert gas, for example, argon, nitrogen or air. Indeed, any inert gas may be used as the atmosphere for the microwaving.

In some embodiments, the exfoliated graphene oxide is simultaneously reduced partially. This partially reduced graphene oxide may be further microwaved to produce high quality microwave-reduced graphene oxide (MW-rGO). In some instances, this MW-rGO contains an oxygen concentration of about 5 atomic % or less.

In some other embodiments, the invention is directed to a method for producing high quality microwave-reduced graphene oxide (MW-rGO) from intercalated graphite that has been oxidized by: (a) providing intercalated graphite that has been oxidized; (b) microwaving the intercalated graphite that has been oxidized to partially remove oxygen from the intercalated graphite to obtain exfoliated graphene oxide; and (c) microwaving the exfoliated graphene oxide to obtain MW-rGO wherein the oxygen concentration is about 5 atomic % or less.

In a further aspect, the present invention is directed to exfoliated graphene oxide and MW-rGO produced according to the above methods.

### Example

In the following Example, sulfuric acid, potassium permanganate, sodium nitrate, nickel nitrate and iron nitrate were purchased from Sigma Aldrich and used as received. SiO₂/Si wafers (300 nm thick SiO₂ layer on a highly doped p-type Si(100)) were purchased from Nova Electronic Materials. Ultra-high purity argon was purchased from Airgas.

In this exemplary embodiment of the invention, graphene oxide (GO) was prepared by using the modified Hummers' method to oxidize graphite and solubilize it into monolayered graphene oxide flakes in water. GO was prepared from natural graphite by the modified Hummers' method. Graphite powder (1.5 g) was immerged into cold concentrated H₂SO₄ (50.7 mL) with sodium nitrate (1.14 g). KMnO₄ (6 g) was added slowly while stirring for 2 hours. After 3 days, 5% H₂SO₄ solution (150 mL) was slowly added and the reaction was finally terminated by the addition of 30% H₂O₂ (4.5 mL), after which the color of the solution changed to bright yellow. The mixture was washed with 10% HCl in order to remove metal ions. The solution was then cleaned via dialysis (molecular weight cut-off=14,000, Sigma-Aldrich) to remove metal ions and acids completely. The GO product was centrifuged at low speed in order to remove smaller flakes and finally at 6000 rpm for 30 minutes to concentrate the solution. The GO solution (5.7 mg/mL) was injected at a 0.1 mL/min of flow rate into a coagulation bath (1 wt % aqueous CaCl₂) solution) using a syringe pump. Coagulated GO was then washed with deionized water and dried in air.

After drying in air, annealing the GO was then performed. The GO was slightly reduced by thermal annealing at 300° C. for 1 hour under argon.

Next, the microwaving step was performed. The annealed, slightly reduced GO was placed in a vial and microwaved (via a Panasonic microwave oven, 1000 W) for 1-2 seconds under argon.

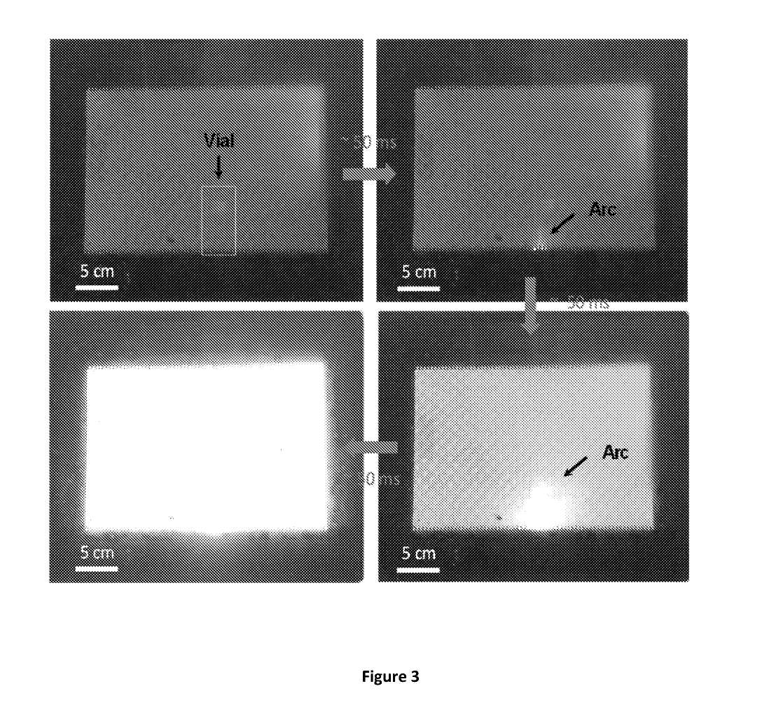

Upon microwave irradiation, large arcing was observed around the annealed GO, as shown in FIG. 3. The arcs were observed to typically last 50-100 milli-second (ms), which suggests an extremely fast annealing process during which GO is heated up to several thousands of degrees Celsius in only a few tens of ms. The resulting microwave-reduced graphene oxide (MW-rGO) was then allowed to cool for a few minutes. In contrast, no arcs were observed when microwaving graphene oxide (i.e., graphene oxide not subject to the annealing step), thereby confirming the importance of the annealing step in the present invention.

Although irradiation of graphene oxide with microwaves has been previously reported, the reduction efficiency has been low and the reduced graphene oxide remains highly disordered as indicated by the presence of an intense and broad disorder D band and absence of the 2D band in their Raman spectra (Chen, Carbon, 2010; Zhu, Carbon, 2010; Hu, Carbon, 2012). In the present example, the GO was irradiated after deposition to achieve exceptionally high-quality rGO. Although not wishing to be bound by any particular theory, we infer that absorption of microwaves led to rapid heating of the GO (see FIG. 3), causing desorption of oxygen functional groups as well as reordering of the graphene basal plane.

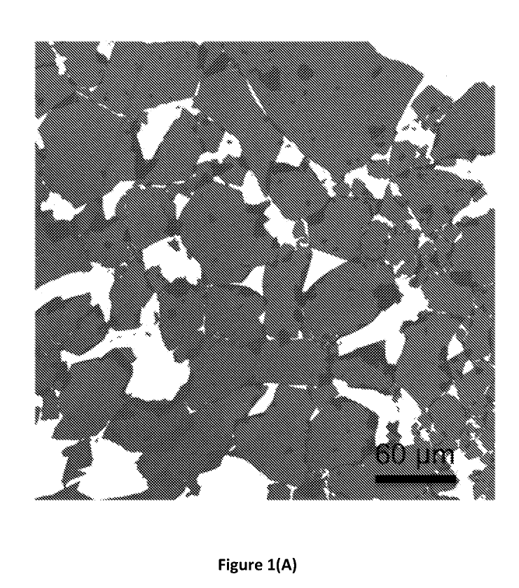

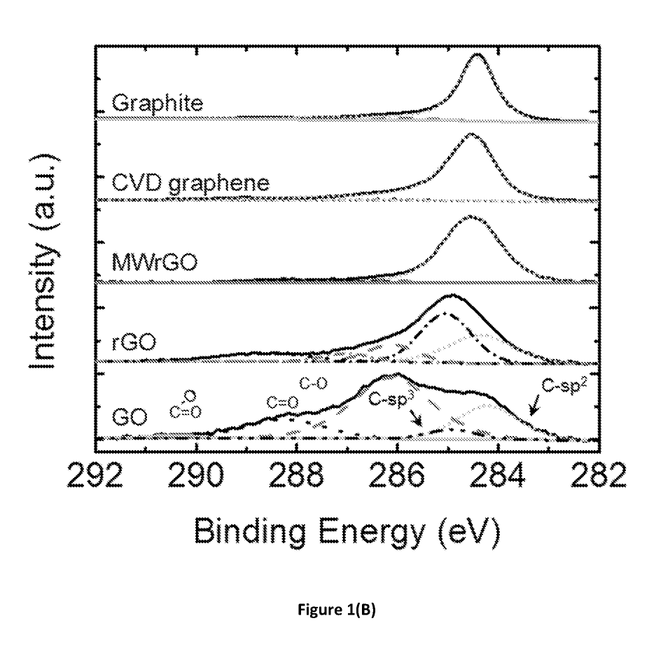

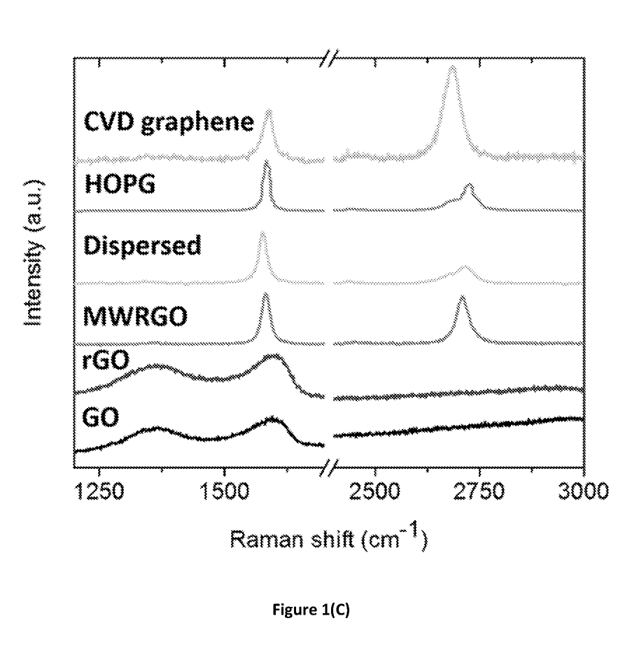

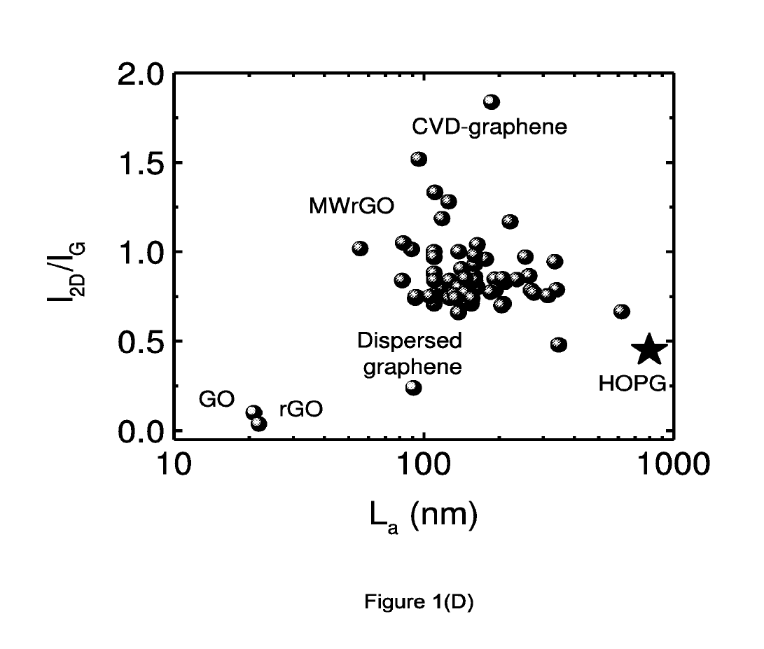

In this example, the physical properties of the resulting microwave-reduced graphene oxide (MW-rGO) were analyzed. FIG. 1 shows the physical characterization of MW-rGO compared to pristine graphene oxide (GO), reduced graphene oxide (rGO) and CVD-grown graphene (CVD graphene).

Graphene oxide (GO), reduced graphene oxide (rGO), and microwave-reduced graphene oxide (MW-rGO) sheets were characterized by a field-emission scanning electron microscope (SEM) with an accelerating voltage of 5 kV. High-resolution transmission electron microscopy (HRTEM) data was acquired by a FEI Titan G2 60-300 with an image-forming C_{S} corrector at an accelerating voltage of 80 kV. MW-rGO and rGO were sonicated in N-methyl-2-pyrrolidone (NMP) and then dropped onto holey carbon TEM grids for analysis.

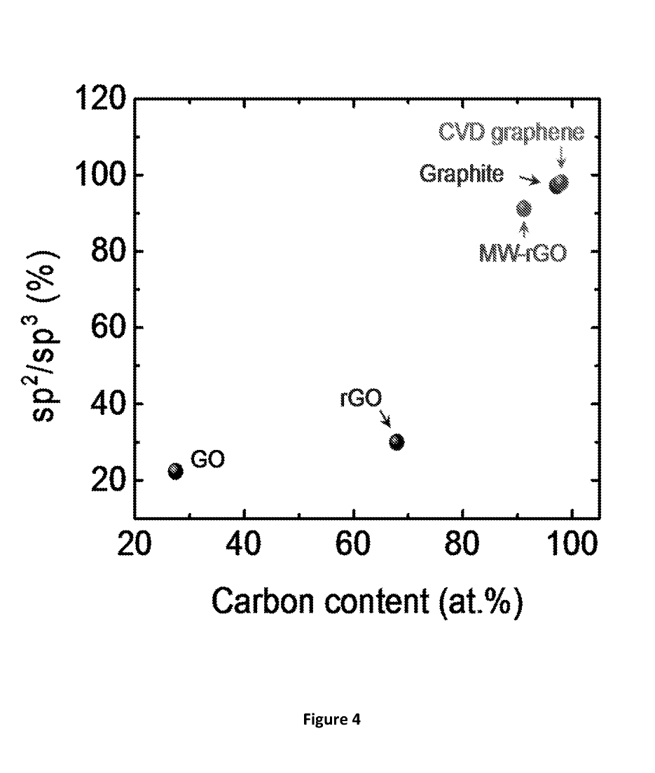

X-ray photoelectron spectroscopy (XPS) was employed to characterize the surface chemistry of CVD graphene, MW-rGO, rGO and GO using a Thermo Scientific K-Alpha spectrometer. All spectra were acquired using a microfocused monochromatized source (1,486.7 eV) with a spot size of 400 μm and a resolution of 0.6 eV. All samples for XPS were deposited onto a Au substrate. The surface chemistry of graphene oxide has been intensively studied in the literature and is composed of various functional groups including epoxy, hydroxyl, ketone, phenol, lactone and carboxylic acid functions (Mattevi, Adv Funct Mater, 2009; Bagri, Nat Chem, 2010). The deconvolution of the Cls spectrum of GO confirms the presence of all these chemical groups on the surface of the graphene oxide nanosheets with peaks at ˜286.4 eV, ˜287.8 eV and ˜288.9 eV attributed to the C—O, C═O and O—C═O bonds, respectively, in agreement with previous works from the literature (Mattevi, Adv Funct Mater, 2009) (see FIG. 1(B)). Additionally, C—C peak from the sp² carbons is slightly shifted relative to the peak from the sp³ hybridized carbons at 284.5 eV and 285 eV, respectively, and thus the C—C peak can be deconvoluted with two Lorentzian curves. Upon mild reduction at 500° C., a significant amount of oxygen groups are removed as shown in FIG. 1(B). At the opposite CVD-grown graphene, which consists in conjugated sp² carbons, it contains almost no oxygenated chemical groups. Signals for MW-rGO are virtually identical to ones obtained for CVD-grown graphene indicating similar surface chemistry (see FIG. 1(B)). Deconvolution of the Cls regions allows for quantifying the density of the functional groups as well as the amount of sp² and sp³ carbon atoms. FIG. 4 shows the evolution of the sp² atoms with the carbon content for graphene and all the GO-derived samples. From FIG. 4, it can be seen that the carbon content in MW-rGO is significantly larger than for mildly reduced rGO: >90% vs. ˜70%, respectively, whereas the percentage of sp² carbon atoms is three times higher in MW-rGO than in rGO, and very close to CVD graphene.

The XPS results (in FIG. 1(B)) indicate that MW-rGO was substantially reduced with in plane oxygen concentration of ˜4 atomic %, much lower that what is theoretically predicted for rGO after annealing to 1500 K (Bagri, Nat Chem, 2010). Approximately 3 atomic % of noncovalently bonded adsorbed oxygen was also found in MW-rGO, CVD graphene, and graphite powder as indicated by the fits in FIG. 1(B). The full width at half maximum (FWHM) of the XPS peak is slightly higher in the case of MW-rGO than for CVD graphene and bulk graphite, suggesting that a small amount of disorder is still present.

Raman spectroscopy was used in order to estimate the reduction of the different GO-derived samples. Raman spectra were obtained using a Renishaw 1000 system operating at 514 nm (2.41 eV). CVD-grown graphene was synthesized following the method from X. Li et al., Nano Lett. 10, 4328-4334 (2010). Data from dispersed graphene was taken from the article by K. R. Paton et al., Scalable production of large quantities of defect-free few-layer graphene by shear exfoliation in liquids, Nat. Mater. 13, 624-630 (2014). Reduced graphene oxide was prepared by annealing graphene oxide under argon for one hour at 500° C.

The Raman spectra of MW-rGO along with those of thermally reduced GO, CVD graphene, liquid exfoliated graphene, and HOPG for comparison are shown in FIG. 1(C). The samples were deposited on a SiO₂/Si wafer and Raman spectra were corrected to the position of silicon peak at 520 cm⁻¹. Raman spectroscopy is a powerful tool to investigate the structure and thus the intrinsic quality of nanocarbons, such as carbon nanotubes and graphene. Raman spectrum of ideal graphene consists of three main peaks: a D peak at ˜1350 cm⁻¹ coming for the sp³ carbons from defects (D band is thus virtually absent in high quality graphene), a G peak at ˜1580 cm′ attributed to the sp² carbons, and an intense 2D (also noted G′) peak at ˜2700 cm⁻¹ that is the second order mode of the D band (Cançado, Nano Lett, 2011; Ferrari, Nat Nanotechnol, 2013). In monolayer graphene, the 2D band is expected to be higher than the G peak (typically 2-3 times higher) and perfectly symmetrical. The influence of defects on the vibrational response of graphene and graphite has been intensively investigated in the last several decades. An empirical formula has been deduced from the evolution of the D and G peaks with the distance between defects: L_{D} (Equation (Eq. I)) (Ferrari and Basko, Nat Nanotechnol, 2013):

$${L}_{D}^{2} ( {nm}^{2} ) = ( 1.8 \pm 0.5 ) \times {10}^{- 9} \times {λ}^{4} \times {( \frac{{I}_{D}}{{I}_{G}} )}^{- 1} , \qquad ( Eq . I )$$

where λ (in nm), I_{D} and I_{G} represent the wavelength of the Raman laser and the intensity of the D and G band, respectively. For L_{D}>10 nm, the density of defects, n_{D}, can be estimated using Equation (Eq. II) (Cançado, Nano Lett, 2011):

$${n}_{D} ( {cm}^{- 2} ) = \frac{( 1.8 \pm 0.5 ) \times {10}^{22}}{{λ}^{4}} \times ( \frac{{I}_{D}}{{I}_{G}} ) \qquad ( Eq . II )$$

The size of the crystalline domains, Lₐ, can be estimated from the Raman signals using Equation (Eq. III) (Cançado, Appl Phys Lett, 2006):

$${L}_{a} ( nm ) = ( 2.4 \times {10}^{- 10} ) \times {λ}^{4} \times {( \frac{{I}_{D}}{{I}_{G}} )}^{- 1} \qquad ( Eq . III )$$

Raman spectroscopy was performed on CVD-grown graphene, graphene oxide and reduced graphene oxide samples deposited on a silicon dioxide wafer. High reduction of the graphene oxide after microwaving is clearly seen in FIG. 1(C) (MW-rGO). Notably, the D peak intensity is dramatically reduced whereas the restoration of the 2D band clearly shows that the structure of sp² carbon for MW-rGO is largely restored. Raman analysis of hundreds of MW-rGO samples reveals that the I_{2D}/I_{G} ratio is close to or higher than 1, whereas the I_{G}/I_{D} ratio is larger than 10. Such evolution of the D and 2D peaks largely differs from rGO samples even after annealing at temperatures as high as 1000° C. (Xin, Science 2015) or chemical reduction using hydrazine (Moon, Nat Commun, 2010; Park, Nat Commun, 2012), hydroiodic acid (Eigler, Adv Mater, 2013), or ascorbic acid (Zhang, Chem Comm, 2010).

Table 1 below summarizes the main properties of MW-rGO compared to CVD-grown graphene and dispersed graphene. In addition, we compared the effect of microwaving time on the reduction of the graphene oxide nanosheets, and we observed that microwaving pulses as short as 1 to 2 seconds at 1000 W lead to optimal reduction, whereas longer times or higher power don't further improve the reduction of graphene oxide. From the Raman spectra in FIG. 1(C), it is shown that microwave treatments almost completely remove the oxygen functional groups, restore the crystallinity of the nanosheets and significantly increase the size of sp² domains.

TABLE 1
Crystal size (Lₐ), distance between defects (L_{D}) and defect density (n_{D})
of MW-rGO compared to CVD-grown graphene and dispersed graphene.

| | Lₐ (nm) | L_{D} (nm) | n_{D} (cm⁻²) |
|---|---|---|---|
| CVD-grown graphene | 186 | 36 | 2.28 × 10¹⁰ |
| Dispersed graphene | 90.9 | 26 | 4.68 × 10¹⁰ |
| MW-rGO | 180 ± 77 | 38 ± 8 | 2.87(±1.45) × 10¹⁰ |

The MW-rGO exhibited highly ordered graphene-like Raman features with sharp and symmetrical 2D and G peaks and a nearly absent D peak (see FIG. 1(C)). The Raman spectrum for the MW-rGO (see FIG. 1(C)) more closely resembled that of CVD graphene than the broad and highly disordered spectrum of thermally reduced rGO or that of solution exfoliated graphene films where the 2D peak is weak and the disorder induced D peak is also visible. The Raman spectra of MW-rGO are also different from those of electrochemically exfoliated graphene, chemically reduced GO and microwave exfoliated graphene oxide (MEGO), all of which exhibit high D band and moderate or no 2D band.

In addition, the I_{2D}/I_{G} Raman peak ratios as a function of the graphene domain sizes have been extracted and plotted in FIG. 1(D). As can be seen in FIG. 1(D), MW-rGO exhibits substantially higher I_{2D}/I_{G} ratios and larger graphene domain sizes than rGO and solution exfoliated flakes.

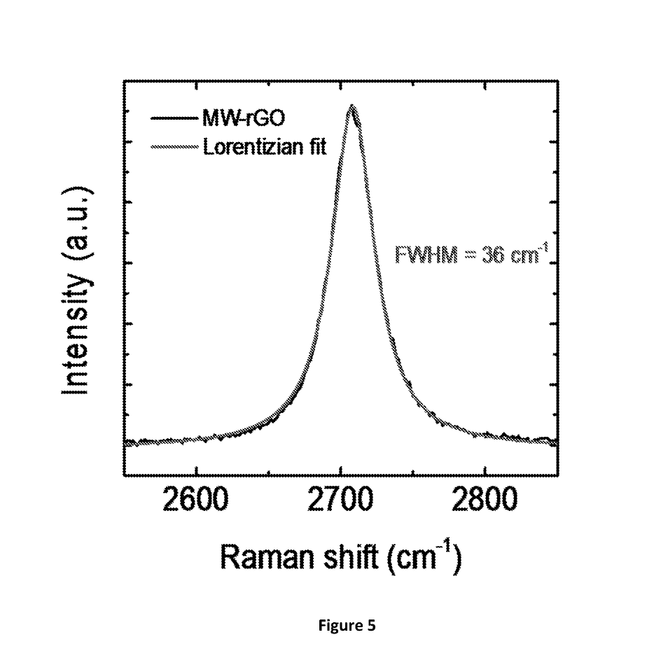

It is also worth noting that the high I_{2D}/I_{G} ratio combined with the symmetrical shape of the 2D peak for MW-rGO suggests the presence of single layer nanosheets (see FIG. 5). The full width at half maximum (FWHM) of 36 cm⁻¹ is close to the value expected for single-layer graphene, and much smaller than in the case of randomly stacked single-layer graphene (˜50 cm⁻¹).

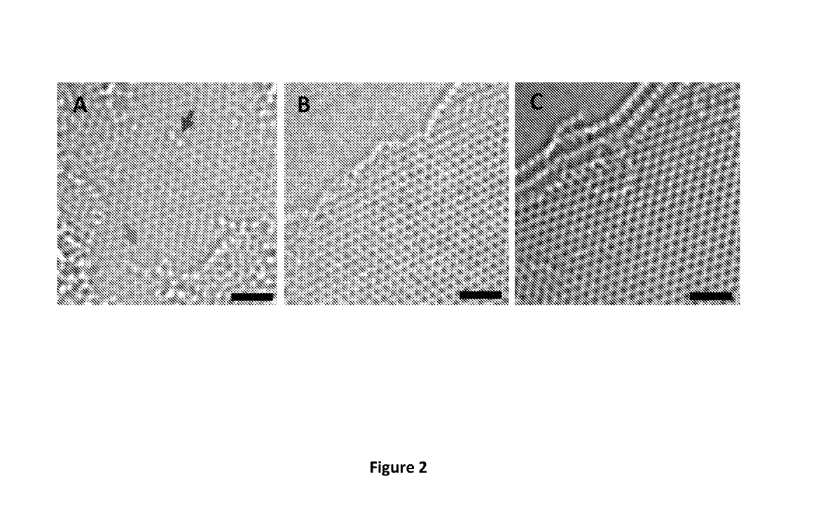

Raman spectroscopy gives structural information averaged over regions a few micrometers in diameter. In FIG. 2, we investigated local atomic structure using aberration corrected HRTEM. Thermally reduced GO exhibited the well-known disordered structure with holes and oxygen functional groups on the surface (see FIG. 2(A)). The MW-rGO exhibited highly ordered structure at the atomic scale (see FIGS. 2(B) and 2(C)), suggesting that there is some reorganization of the carbon bonding during microwave reduction along with removal of oxygen facilitated by achieving exceptionally high temperatures.

To examine whether the highly ordered structure of MW-rGO can be translated into useful properties, it was implemented as the channel in FETs and as a catalyst support for the oxygen evolution reactions. The mobility values in graphene have been used as a parameter for assessing the quality of the material (Petrone, Nano Lett, 2012). To this end, several studies have reported high mobility values of rGO (100 to 1000 cm²/V-s) to demonstrate efficacy of various reduction treatments or synthesis procedures (Wang, Nano Lett, 2010; Feng, Nat Commun, 2013; Eigler, Adv Mater, 2013). However, mobility values alone cannot provide information about the structural integrity of the material. Previous reports on high mobility rGO are accompanied by Raman spectra containing large D bands and weak 2D bands along with oxygen concentration of 5 to 8%, suggesting substantial disorder (Eigler, Adv Mater, 2013). Thus, mobility values >˜1 cm²/V-s have not been widely reproducible in rGO.

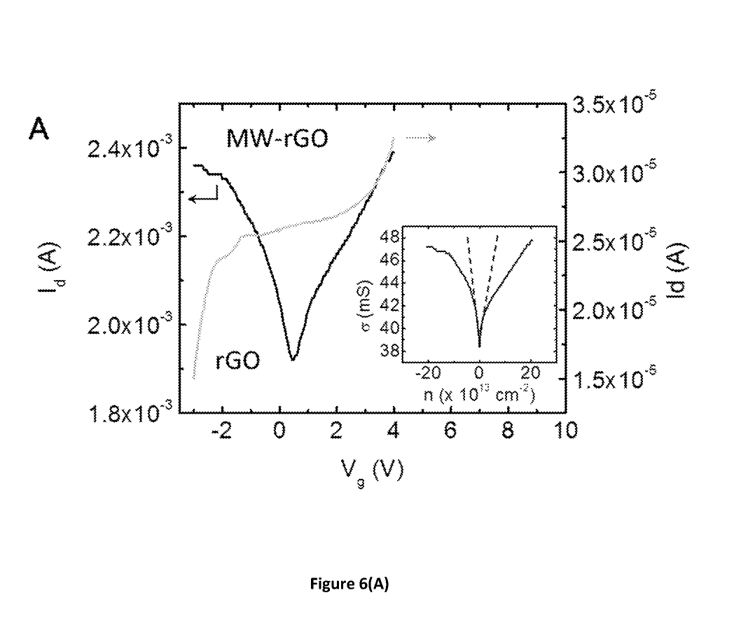

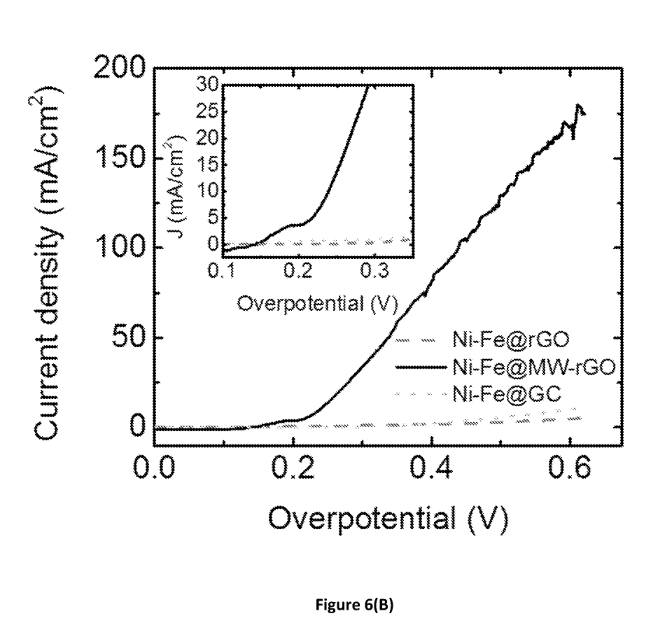

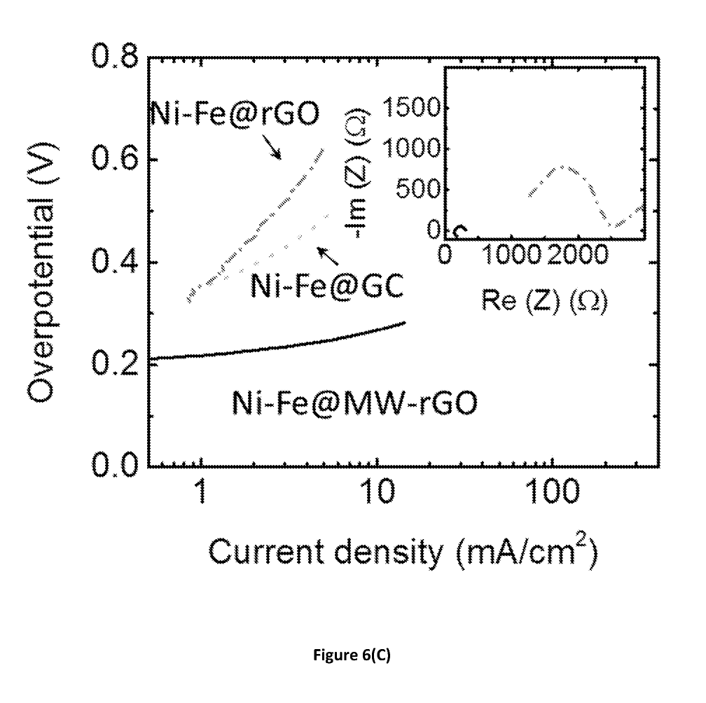

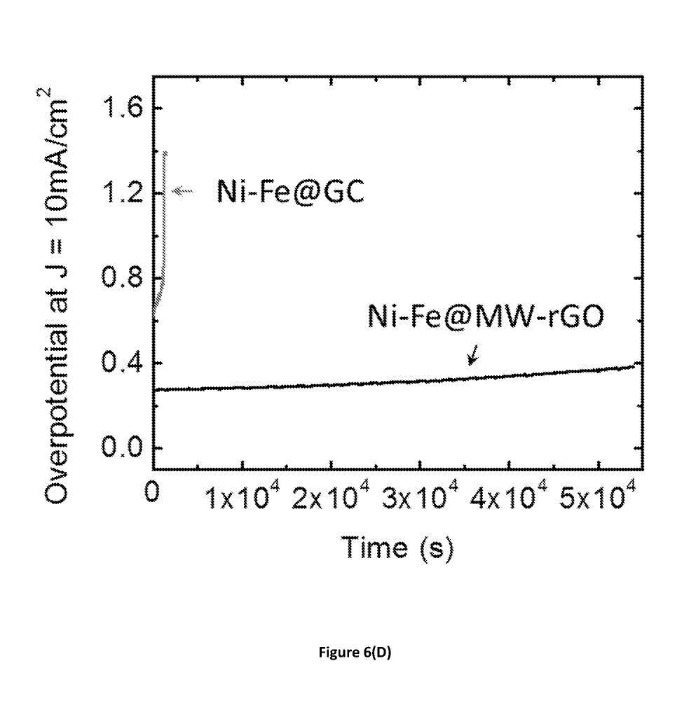

FIG. 6 shows the characterization of the electronic and electrocatalytic properties of MW-rGO. Transfer characteristics of field-effect transistors (FETs) from MW-rGO on SiO2 are shown in FIG. 6(A). Field-effect transistors made of rGO and MW-rGO were fabricated in two-terminal configuration using silver as contacts for both the source and the drain electrodes. Ionic liquid (Bimm PF6) was used as the gate dielectric and offers a high double-layer capacitance (Cdl) of ˜20 μF/cm². Platinum wire was used as the top-gate electrode. Contacts were passivated prior to any measurements so that only MW-rGO (or rGO) is exposed to the ionic liquid. Drain currents in the milliamps range can be measured. The electrical properties of thermally reduced GO FETs are also shown for comparison in FIG. 6(A), and they exhibit substantially lower current values. The absence of the Dirac point in the case of rGO is attributed to the poorly reduced and highly disordered structure of the nanosheets. Additionally, the presence of adsorbates and oxygen impurities are known to dramatically shift the position of the Dirac point and to modify the FET characteristics.

The carrier mobility was calculated from the transfer characteristics of the transistors following methods from the literature. The carrier concentration has been estimated using Equation (Eq. IV):

$$\vert {V}_{G} - {V}_{G min} \vert = \frac{h \times {υ}_{F} \times \sqrt{π n}}{e} + \frac{ne}{{c}_{dl}} , \qquad ( Eq . IV )$$

where h, ν_{F}, e and V_{G} represent the reduced Planck's constant, the Fermi velocity for the Dirac cone electrons, the electron charge and the gate potential, respectively.

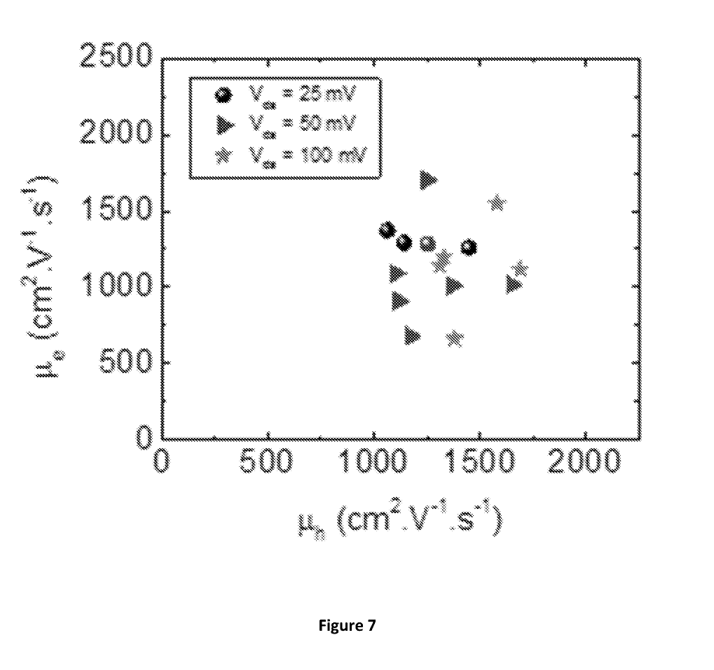

The mobility (μ) was then obtained from Equation (Eq. V):

$$μ = ( \frac{d σ}{dn} ) \times \frac{1}{e} , \qquad ( Eq . V )$$

where σ is the conductivity of the channel. Numerous FET devices were fabricated and tested using six (6) different batches of graphene oxide (see FIG. 7). High carrier mobilities were consistently obtained from MW-rGO samples, confirming the high quality of the microwave reduction.

The mobility values extracted from FET measurements were >1000 cm²-V⁻¹-s⁻¹ for holes and electrons in MW-rGO (see Inset of FIG. 6(A); FIG. 7). The FETs measured here consist of large channel dimensions so that transport of carriers occurs over numerous flakes. Despite this fact, exceptionally high mobility values were obtained in MW-rGO, suggesting that individual flakes have very good transport properties.

Highly conducting carbon-based electrodes that are electrochemically stable are important for applications in catalysis and energy storage. Catalysts are typically loaded on highly conducting substrates (working electrode) such as carbon cloth, glassy carbon or nickel foam. The properties of MW-rGO as a catalyst support in the oxygen evolution reaction were examined by depositing Fe and Ni layered double hydroxide (LDH) on MW-rGO.

The electrochemical measurements were performed in a three-electrode configuration using a saturated calomel electrode (SCE) and a graphite rod as reference and counter electrodes, respectively. The saturated calomel electrode (SCE) was calibrated against platinum under 1 bar of H₂ in a 0.1 M KOH solution saturated with H₂. In 0.1 M KOH, we measured: E_{RHE}=E_{SCE}+949 mV. The electrochemical measurements were carried out using a Multistat 1480 potentiostat from Solartron Group. Electrochemical impedance spectroscopy (EIS) was investigated by using a SI-1260 Impedance/Gain Phase analyzer (Solartron) at η=0.2-0.250 V from 10⁶ to 0.1 Hz with an alternating current voltage of 10 mV. Oxygen Evolution Reaction (OER) (2OH⁻=½O₂+H₂O+2e⁻) performance of the electrodes was evaluated in a 0.1 M KOH electrolyte solution. The electrodes were first cycled for >50 cycles before any measurement in order to stabilize the electrochemical response. Polarization curves were obtained by sweeping the potential of the working electrode from 0 mV to +900 mV vs. the reference electrode at a scan rate of 5 mV·s⁻¹.

Ni—Fe LDH was electrodeposited on the MW-rGO (rGO) nanosheets using a 3-electrode cell as described above. A 5 milli-molar (mM) aqueous solution of Ni(NO₃)₂ and Fe(NO₃)₃ with a molar ratio of Ni:Fe=1:1 was used as electrolyte and as the source of Ni and Fe. Electrodeposition of Ni—Fe LDH nanosheets was achieved by applying a constant potential of −1000 mV for 60 seconds to 300 seconds. The deposition time was optimized and it was found that 240 seconds gives the best performance in terms of current density and overpotential. After deposition, the electrodes were rinsed with water and ethanol and finally dried in air.

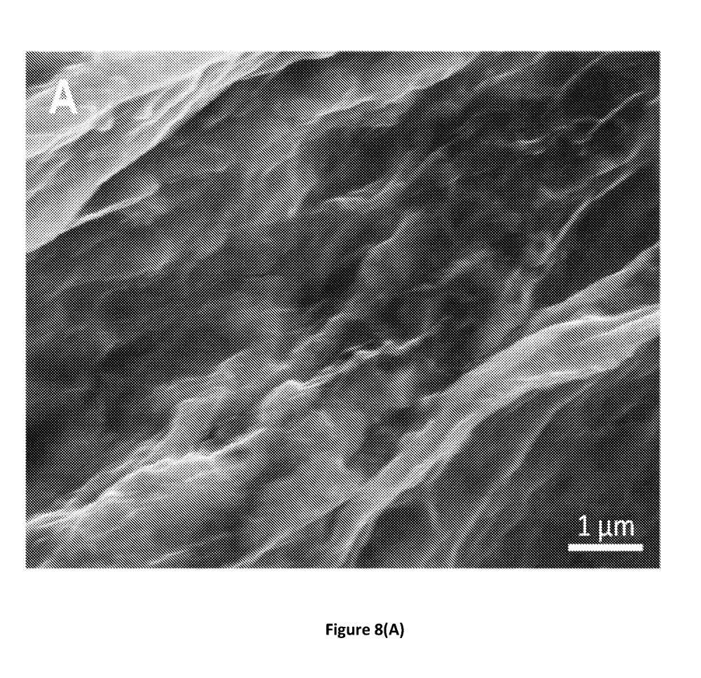

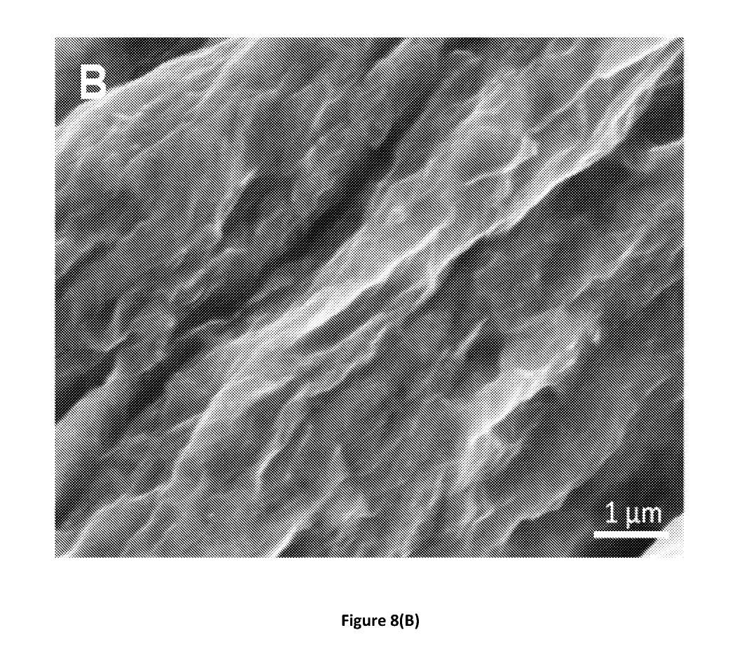

The MW-rGO and rGO fibers were observed by scanning electron microscopy, as shown in FIGS. 8 (A) and 8(B). FIGS. 8(A) and 8(B) show a similar physical structure of the NiFe LDH nanosheets on both supports, suggesting that the intrinsic activity and the amount of active sites don't vary significantly between MW-rGO and the rGO.

As shown in FIG. 6(B), the OER properties of Fe—Ni LDH catalysts on MW-rGO, rGO, and glassy carbon electrodes show that the overpotential at which the reaction starts decreased to <200 mV and the current density rapidly increased when MW-rGO was used as the catalyst support. To obtain insight into surface chemistry mechanisms, we have extracted the Tafel slopes from measurements on different supports, as shown in FIG. 6(C). The MW-rGO catalyst supports exhibit exceptionally low Tafel slopes of 38 mV/dec, which may indicate that the reaction MO+OH⁻=MOOH+e⁻ is the rate-determining step (where M represents an active site on the catalyst surface). The much higher Tafel slopes for glassy carbon and rGO electrodes of 170 mV/dec and 360 mV/dec, respectively, suggest limiting reactions are caused by adsorption of hydroxide ions (M+OH⁻=MOH+e⁻) because of the poor electrical coupling between the catalyst and support (Shinagawa, Sci Rep., 2015). The limited electrical coupling is highlighted by the inset in FIG. 6(C), which shows that the impedance of the electrochemical circuit is substantially lowered when using MW-rGO, which allows the OER to proceed efficiently. Electrochemical stability of the catalysts and their supports is an important parameter in catalysis. As shown in FIG. 6(D), the stability of MW-rGO supports was maintained for more than 15 hours, in contrast with glassy carbon supports that degraded almost immediately after the reaction started.

Furthermore, similar measurements were made for the hydrogen evolution reaction (HER), wherein we obtained exceptional performance for MW-rGO catalyst supports as well as very high stability for more than 100 hours. The HER electrodes were prepared by depositing amorphous MoS_{X} on the reduced GO nanosheets. The rGO and MW-rGO nanosheets were dip-coated in a saturated (NH₄)₂MoS₄ aqueous solution (Sigma-Aldrich). After deposition, the electrodes were rinsed with water and ethanol and dried.

HER (2H⁺+2e⁻=H₂) measurements were performed in a 0.5 M H₂SO₄ solution. Electrodes were cycled as described above. Cycling voltammetry was then performed between +100 mV and −700 mV vs. the reference electrode at a scan rate of 5 mV·s⁻¹. The SCE electrode was calibrated against platinum under 1 bar of H₂ in a 0.5 M H₂SO₄ solution saturated with H₂. In 0.5 M H₂SO₄, we measured: E_{RHE}=E_{SCE}+256 mV.

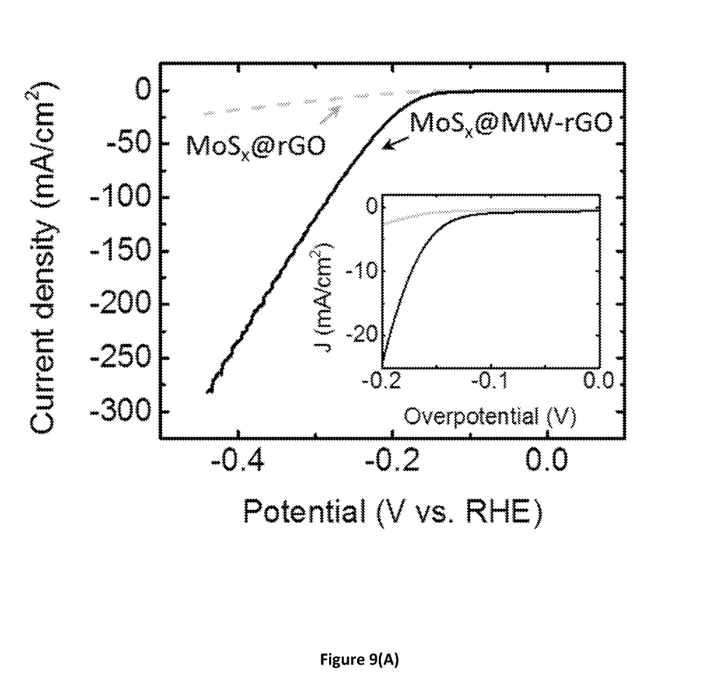

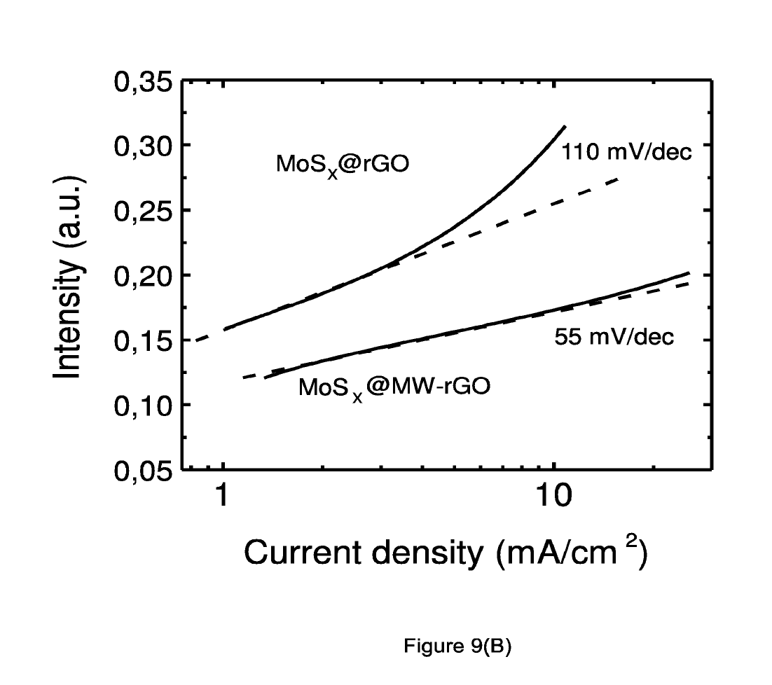

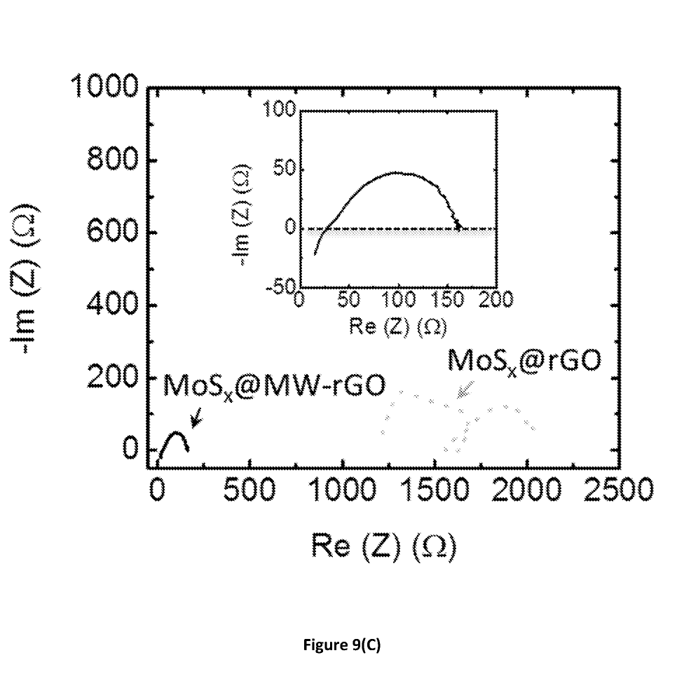

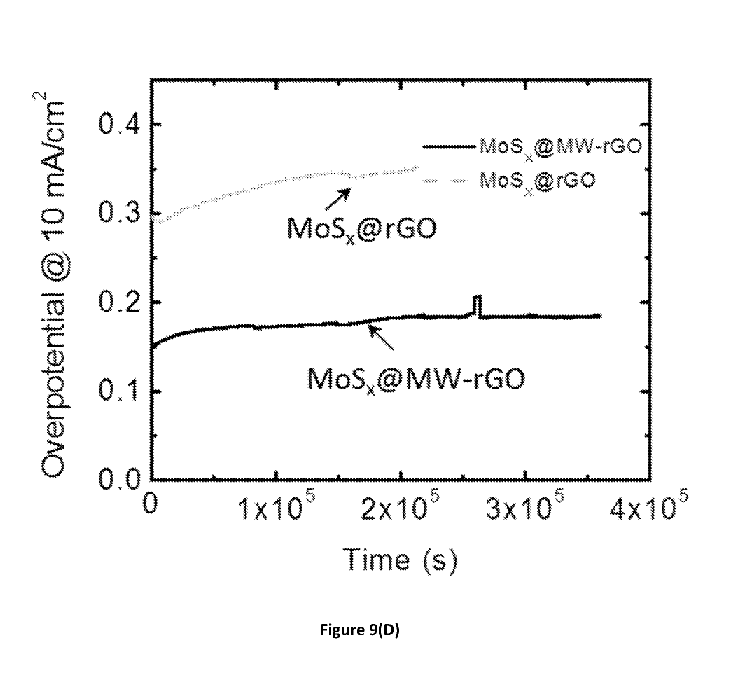

FIGS. 9(A) and 9(B) show the polarization curves and the corresponding Tafel plots for the MoS_{X}@rGO and MoS_{X}@MW-rGO electrodes. In the case of MW-rGO, there is a dramatic increase of the absolute current density together with a decrease of the overpotential. Onset-potentials as low as ˜100 mV are obtained when using MW-rGO as a conducting support Similar improvement of the electrocatalytic behavior is observed for the Tafel slope with a decrease of the Tafel slope from >300 mV/dec for MoS_{X}@rGO down to ˜50 mV/dec for MoS_{X}@MW-rGO (see FIG. 9(B)). Such a large decrease of the Tafel demonstrates the improved kinetics at the active sites due to faster electron transfer between MW-rGO and MoS_{X}. This is also supported by the EIS data in FIG. 9(C), which shows that both the internal resistance (Z_{S}) and the charge transfer resistance (Z_{CT}) are significantly reduced when using microwave-reduced graphene oxide. Notably, the internal resistance drops from 1250 to <15 due to the high conductivity of MW-rGO.

Finally, the stability of the MoS_{X}@MW-rGO electrode was tested over 100 hours to ensure that the electrodes sustain high activity over a long period of time. FIG. 9(D) shows the galvanostatic measurements for both MoS_{X}@rGO and MoS_{X}@MW-rGO during 100 hours. These results demonstrate the high stability of the MW-rGO electrode with a virtually constant overpotential to supply 10 mA·cm⁻².

The foregoing example and description should be taken as illustrating, rather than limiting, the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

All references cited herein are incorporated by reference herein in their entireties.

As used in this application, including the appended claims, the term “about,” particularly in reference to a given quantity, is meant to encompass deviations of plus or minus ten percent.

As used herein, the singular forms “a,” “an,” and “the” include plural references, unless the content clearly dictates otherwise, and are used interchangeably with “at least one” and “one or more.”

As used herein, the terms “comprises,” “comprising,” “includes,” “including,” “contains,” “containing,” and any variations thereof, are intended to cover a non-exclusive inclusion, such that a process, method, product-by-process, or composition of matter that comprises, includes, or contains an element or list of elements does not include only those elements but can include other elements not expressly listed or inherent to such process, method, product-by-process, or composition of matter.

### REFERENCES

Ashok Kumar N, Gambarelli S, Duclairoir F, et al (2013) Synthesis of high quality reduced graphene oxide nanosheets free of paramagnetic metallic impurities. J Mater Chem A 1:2789-2794. doi: 10.1039/C2TA01036D
Bagri A, Mattevi C, Acik M, et al (2010) Structural evolution during the reduction of chemically derived graphene oxide. Nat Chem 2:581-587. doi: 10.1038/nchem.686
Cançado L G, Jorio A, Ferreira E H M, et al (2011) Quantifying Defects in Graphene via Raman Spectroscopy at Different Excitation Energies. Nano Lett 11:3190-3196. doi: 10.1021/n1201432g
Cançado L G, Takai K, Enoki T, et al (2006) General equation for the determination of the crystallite size La of nanographite by Raman spectroscopy. Appl Phys Lett 88:163106. doi: 10.1063/1.2196057
Chen W, Yan L, Bangal P R (2010) Preparation of graphene by the rapid and mild thermal reduction of graphene oxide induced by microwaves. Carbon 48:1146-1152. doi: 10.1016/j.carbon.2009.11.037
Chen Y, Fu K, Zhu S, et al (2016) Reduced Graphene Oxide Films with Ultrahigh Conductivity as Li-Ion Battery Current Collectors. Nano Lett 16:3616-3623. doi: 10.1021/acs.nanolett.6b00743
Chua C K, Sofer Z, Pumera M (2012) Graphite Oxides: Effects of Permanganate and Chlorate Oxidants on the Oxygen Composition. Chem—Eur J 18:13453-13459. doi: 10.1002/chem.201202320
Dong L, Chen Z, Lin S, et al (2017) Reactivity-Controlled Preparation of Ultralarge Graphene Oxide by Chemical Expansion of Graphite. Chem Mater 29:564-572. doi: 10.1021/acs.chemmater.6b03748
Dong Z, Jiang C, Cheng H, et al (2012) Facile Fabrication of Light, Flexible and Multifunctional Graphene Fibers. Adv Mater 24:1856-1861. doi: 10.1002/adma.201200170
Eigler S, Enzelberger-Heim M, Grimm S, et al (2013) Wet Chemical Synthesis of Graphene. Adv Mater 25:3583-3587. doi: 10.1002/adma.201300155
Feng H, Cheng R, Zhao X, et al (2013) A low-temperature method to produce highly reduced graphene oxide. Nat Commun 4:1539. doi: 10.1038/ncomms2555
Ferrari A C, Basko D M (2013) Raman spectroscopy as a versatile tool for studying the properties of graphene. Nat Nanotechnol 8:235-246. doi: 10.1038/nnano.2013.46
Hu H, Zhao Z, Zhou Q, et al (2012) The role of microwave absorption on formation of graphene from graphite oxide. Carbon 50:3267-3273. doi: 10.1016/j.carbon.2011.12.005
Hummers W S, Offeman R E (1958) Preparation of Graphitic Oxide. J Am Chem Soc 80:1339-1339. doi: 10.1021/ja01539a017
Kiang Chua C, Pumera M (2014) Chemical reduction of graphene oxide: a synthetic chemistry viewpoint. Chem Soc Rev 43:291-312. doi: 10.1039/C3CS60303B
Mattevi C, Eda G, Agnoli S, et al (2009) Evolution of Electrical, Chemical, and Structural Properties of Transparent and Conducting Chemically Derived Graphene Thin Films. Adv Funct Mater 19:2577-2583.
Moon I K, Lee J, Ruoff R S, Lee H (2010) Reduced graphene oxide by chemical graphitization. Nat Commun 1:73. doi: 10.1038/ncomms1067
Park S, Hu Y, Hwang J O, et al (2012) Chemical structures of hydrazine-treated graphene oxide and generation of aromatic nitrogen doping. Nat Commun 3:638. doi: 10.1038/ncomms1643
Pei S, Zhao J, Du J, et al (2010) Direct reduction of graphene oxide films into highly conductive and flexible graphene films by hydrohalic acids. Carbon 48:4466-4474. doi: 10.1016/j.carbon.2010.08.006
Petrone N, Dean C R, Meric I, et al (2012) Chemical Vapor Deposition-Derived Graphene with Electrical Performance of Exfoliated Graphene. Nano Lett 12:2751-2756. doi: 10.1021/n1204481s
Shin H-J, Kim K K, Benayad A, et al (2009) Efficient Reduction of Graphite Oxide by Sodium Borohydride and Its Effect on Electrical Conductance. Adv Funct Mater 19:1987-1992. doi: 10.1002/adfm.200900167
Shinagawa T, Garcia-Esparza A T, Takanabe K (2015) Insight on Tafel slopes from a microkinetic analysis of aqueous electrocatalysis for energy conversion. Sci Rep. doi: 10.1038/srep13801
Wang S, Ang P K, Wang Z, et al (2010) High Mobility, Printable, and Solution-Processed Graphene Electronics. Nano Lett 10:92-98. doi: 10.1021/n19028736
Xin G, Yao T, Sun H, et al (2015) Highly thermally conductive and mechanically strong graphene fibers. Science 349:1083-1087. doi: 10.1126/science.aaa6502
Xu Y, Sheng K, Li C, Shi G (2010) Self-Assembled Graphene Hydrogel via a One-Step Hydrothermal Process. ACS Nano 4:4324-4330. doi: 10.1021/nn101187z
Zhang J, Yang H, Shen G, et al (2010) Reduction of graphene oxide viaL-ascorbic acid. Chem Commun 46:1112-1114. doi: 10.1039/B917705A
Zhu Y, Murali S, Stoller M D, et al (2010) Microwave assisted exfoliation and reduction of graphite oxide for ultracapacitors. Carbon 48:2118-2122. doi: 10.1016/j.carbon.2010.02.001

We claim:

1. A method for producing microwave-reduced graphene oxide (MW-rGO), comprising:
(a) providing graphene oxide;
(b) reducing the graphene oxide to obtain reduced graphene oxide (rGO) wherein the reduction of oxygen concentration is sufficient to allow microwaves to be absorbed by the rGO; and
(c) microwaving the reduced graphene oxide until a microwave-reduced graphene oxide (MW-rGO) containing an oxygen concentration of about 5 atomic % or less is produced.

2. The method of claim 1, the reduction of oxygen concentration at step (b) is about 0.1% or above.

3. The method of claim 1, the reduction of oxygen concentration at step (b) is about 0.5% or above.

4. The method of claim 1, wherein the graphene oxide is provided by the Hummers' method.

5. The method of claim 1, wherein the graphene oxide is provided by the modified Hummers' method.

6. The method of claim 1, wherein the step of reducing the graphene oxide is by annealing the graphene oxide in an inert atmosphere for 1 or more seconds at a temperature of about 20° C. or higher.

7. The method of claim 6, wherein the step of reducing the graphene oxide is by annealing the graphene oxide in an inert atmosphere for 1 second to about 12 hours at a temperature in the range of about 20° C. to about 1500° C.

8. The method of claim 6, wherein the temperature is in the range of about 200° C. to about 500° C.

9. The method of claim 6, wherein the temperature is at about 300° C.

10. The method of claim 1, wherein the step of reducing the graphene oxide is by using a chemical agent selected from hydrazine, ascorbic acid, hydrohalic acids, sodium borohydride, hydrogen iodide, sulfuric acid, or a combination of thereof.

11. The method of claim 1, wherein the step of reducing the graphene oxide is by UV irradiation.

12. A method for producing microwave-reduced graphene oxide (MW-rGO), comprising:
(a) providing reduced graphene oxide (rGO); and
(b) microwaving the rGO until a MW-rGO containing an oxygen concentration of about 5 atomic % or less is produced.

13. The method of claim 1 or 12, wherein the reduced graphene oxide (rGO) is dry rGO powder.

14. The method of claim 1 or 12, wherein the rGO is wet rGO powder.

15. The method of claim 14, wherein the wet rGO powder is not suspended in a liquid.

16. The method of claim 14, wherein the wet rGO powder contains residual chemical agent used for reducing the graphene oxide.

17. The method of claim 1 or 12, wherein the rGO is in the form of a single graphene layer film.

18. The method of claim 1 or 12, wherein the rGO is in the form of two or more layers to thousands of layers films.

19. The method of claim 1 or 12, wherein the rGO is in the form of 3D structures.

20. The method of claim 1 or 12, wherein the rGO is incorporated into insulating matrices.

21. The method of claim 20, wherein the insulating matrices is polymer matrices.

22. The method of claim 20, wherein the insulating matrices is ceramic matrices.

23. The method of claim 1 or 12, wherein the step of microwaving the rGO is achieved by irradiating the reduced graphene oxide with electromagnetic radiation in the microwave frequency range of about 300 MHz to about 300 GHz, preferably around 2.45 GHz for one or more seconds.

24. The method of claim 1 or 12, wherein the step of microwaving the rGO is performed with a microwave frequency heating device.

25. The method of claim 24, wherein the microwave frequency heating device is a microwave oven with power of about 100 Watt to about 100 kilo Watt.

26. The method of claim 25, wherein the microwave oven is operated at 1000 Watt for 1 or more seconds pulses.

27. The method of claim 24, wherein the microwave frequency heating device is a wave guide.

28. The method of claim 24, wherein the microwave frequency heating device is a resonant cavity.

29. The method of claim 1 or 12, wherein the step of microwaving the reduced graphene oxide is performed under an inert gas atmosphere.

30. The method of claim 29, wherein the inert gas is argon.

31. The method of claim 29, wherein the inert gas is nitrogen.

32. The method of claim 1 or 12, wherein the step of microwaving the reduced graphene oxide is performed under air.

33. A method for exfoliating intercalated graphite, comprising:
(a) providing intercalated graphite that has been oxidized;
(b) microwaving the intercalated graphite that has been oxidized to partially remove oxygen from the intercalated graphite to obtain exfoliated graphene oxide.

34. The method of claim 33, wherein the step of microwaving the intercalated graphite is achieved by irradiating the intercalated graphite with electromagnetic radiation in the microwave frequency range of about 300 MHz to about 300 GHz, preferably around 2.45 GHz for one or more seconds.

35. The method of claim 33, wherein the step of microwaving the intercalated graphite is performed with a microwave frequency heating device.

36. The method of claim 35, wherein the microwave frequency heating device is a microwave oven with power of 100 Watt to 100 kilo Watt.

37. The method of claim 36, wherein the microwave oven is operated at 1000 Watt for 1 or more seconds pulses.

38. The method of claim 35, wherein the microwave frequency heating device is a wave guide.

39. The method of claim 35, wherein the microwave frequency heating device is a resonant cavity.

40. The method of claim 33, wherein the step of microwaving the intercalated graphite that has been oxidized is performed under an inert gas atmosphere.

41. The method of claim 40, wherein the inert gas is argon.

42. The method of claim 40, wherein the inert gas is nitrogen.

43. The method of claim 33, wherein the step of microwaving the intercalated graphite is performed under air.

44. The method of claim 33, further comprising a step of microwaving the exfoliated graphene oxide to obtain MW-rGO after step (b).

45. The method of claim 44, wherein the MW-rGO contains an oxygen concentration of about 5 atomic % or less.

46. A microwave-reduced graphene oxide (MW-rGO) produced according to any one of claims 1-32 and claims 44-45.

47. The microwave-reduced graphene oxide of claim 46, wherein the MW-rGO exhibits sharp G and 2D peaks and a nearly absent or weak D peak in a Raman spectrum.

48. The microwave-reduced graphene oxide of claim 46, wherein the MW-rGO exhibits a highly ordered structure in an analysis by X-ray photoelectron spectroscopy or a high-resolution transmission microscopy.

49. An exfoliated graphene oxide produced according to any one of claims 33-43.

50. A method for producing high quality microwave-reduced graphene oxide (MW-rGO) from intercalated graphite that has been oxidized, comprising the step of:
(a) providing intercalated graphite that has been oxidized;
(b) microwaving the intercalated graphite that has been oxidized to partially remove oxygen from the intercalated graphite to obtain exfoliated graphene oxide; and
(c) microwaving the exfoliated graphene oxide to obtain MW-rGO wherein the oxygen concentration is about 5 atomic % or less.

51. The microwave-reduced graphene oxide of claim 50, wherein the MW-rGO exhibits sharp G and 2D peaks and a nearly absent or weak D peak in a Raman spectrum.

52. The microwave-reduced graphene oxide of claim 50, wherein the MW-rGO exhibits a highly ordered structure in an analysis by X-ray photoelectron spectroscopy or a high-resolution transmission microscopy.
